(19) United States
(12) Patent Application Publication
(10) Pub. No.: US 2026/0285531 A1
(43) Pub. Date: Sep. 24, 2026

(54) HOME COMPOSTABLE CONTAINER

(71) Applicant: THE WATER COMPANY B.V., EMMEN (NL)

(72) Inventors: Sjoerd Jan BOS, HORGEN (CH); Martin Jean José VROSCH, OIRSBEEK (NL); Jozef Maria Hubertus LEMMENS, LANDGRAAF (NL); Marnix VAN GURP, SITTARD (NL)

(21) Appl. No.: 19/489,320

(22) PCT Filed: May 30, 2024
(86) PCT No.: PCT/NL2024/050276

§ 371 Date: Dec. 2, 2025

(30) Foreign Application Priority Data
Jun. 2, 2023 (NL) 2034975

(51) Int. Cl. B65D 1/02; B29C 49/00; B29C 49/04; B29C 49/22; B29K 105/12; B29K 667/00; B29L 31/00; B32B 1/00; B32B 27/08; B32B 27/20; B32B 27/36

(52) U.S. Cl. CPC B65D 1/0207; B29C 49/0005; B29C 49/04; B29C 49/22; B32B 1/00; B32B 27/08; B32B 27/20; B32B 27/36; B29K 2105/12; B29K 2667/00; B29L 2031/7158; B32B 2250/244; B32B 2262/062; B32B 2435/02; B32B 2439/60

(57) ABSTRACT

The invention relates to a container comprising at least one layer of a first polymer composition comprising a co-polyhydroxybutyrate and natural fibre. The container can be a bottle. The container is biodegradable or even home compostable and has a natural look and feel. The invention also relates to a process for producing the container by producing a parison and expanding the parison in a mould.

### FIELD OF THE INVENTION

The present invention relates to a container, in particular a beverage container, comprising a layer of co-polyhydroxybutyrate. The invention also relates to a process for producing such a container.

### BACKGROUND OF THE INVENTION

Beverage containers can be made from a wide variety of materials, such as glass and plastic. Due to their advantages such as low weight and high strength, plastic beverage containers are widely used. Typically, these plastic beverage containers, such as plastic bottles, are produced from conventional plastics that are derived from non-renewable sources including crude oil and natural gas. Apart from being produced from fossil resources, these conventional plastics are also not biodegradable. The most widely used plastic used for the production of plastic beverage containers is polyethylene terephthalate (PET), which is typically derived from non-renewable sources.

Containers and other food packaging products often end up as litter in unwanted places, such as in the street or in forests, rivers, oceans, etc. Because the plastics typically used for food packaging do not decompose rapidly, plastic litter tends to accumulate in the environment in many different forms, such as in the form of microplastics, which is unwanted.

Other containers have been produced from materials that are derived from renewable sources and/or decompose more rapidly than traditional plastics such as PET. Such materials are typically referred to as bio-based plastics and biodegradable plastics, respectively. However, due to several disadvantages of these bio-based and/or biodegradable plastics, these alternative materials have not been as successful as PET. Typically, these bio-based and/or biodegradable plastics have one or more of the following disadvantages when used as a bottle:
lack of physical strength;
too fast biodegradation, leading to short shelf-life of the bottle;
too slow biodegradation;
lack of resistance against high temperatures;
not suitable for carbonated and/or alcoholic drinks;
toxic for humans, animals, and/or plants;
leading to artificial flavors in the beverage in the bottle;
difficult to produce using existing equipment used for bottles made of conventional plastics;
expensive to produce.

A known beverage container is for instance proposed in WO2021/177834, wherein the container comprises a bag of watertight material comprising one or more bio-based and/or biodegradable polymers, and a biodegradable support structure.

A rigid biodegradable food container is described in WO2022/008484. Here the container comprises at least one layer comprising polyhydroxyalkanoate (PHA) and another layer comprising cellulosic fibres.

An object of the present invention is to provide improved containers, such as beverage containers, in particular water bottles, compared to containers made from bio-based and/or biodegradable plastics known in the art. Another object of the present invention is to address one or more of the disadvantages of food packaging made from conventional plastics.

In particular an object of the present invention is to provide a container which is home compostable within 12 months but which can be stocked for at least 12 months and where the quality of the content of the container (water) does not deteriorate during the life time of the container. These properties should be maintained at a wide range of temperature and humidity conditions, e.g. from 4 to 45° C., so that the container can be used in different regions worldwide.

### SUMMARY OF THE INVENTION

According to a first aspect, the present invention provides a container comprising at least one layer of a first polymer composition comprising 80 to 99.5 wt. % of a co-polyhydroxybutyrate, 0.5 to 10 wt. % natural fibre and 0 to 10 wt. % other components, based on the weight of the first polymer composition.

According to a second aspect, the invention provides a closure comprising a co-polyhydroxybutyrate.

According to a third aspect, the invention provides a process for producing a container comprising the steps of:
a) providing a mould for the container;
b) producing a parison, wherein the parison comprises a first polymer composition comprising 80 to 99.5 wt. % of a co-polyhydroxybutyrate 0.5 to 10 wt. % natural fibre and 0 to 10 wt. % other components, based on the weight of the first polymer composition;
c) expanding the parison into the mould to shape a first layer of the container.

Specifically, embodiments of the invention are set forth in the dependent claims.

These and other aspects of the invention will be apparent from and elucidated with reference to the embodiments described hereinafter.

The advantage of the container of the invention is that it is biodegradable, in particular home compostable, that it is sufficiently stable during storage, and that is has a natural look and feel.

A surprising aspect is that the natural fibres are homogeneously distributed in the polymer without the appearance of voids or other defects. A further advantage is that the container obtained can be translucent, such that the contents of the container is largely visible.

### DETAILED DESCRIPTION OF THE PREFERRED EMBODIMENTS

The first layer of the container of the invention comprises a first polymer composition comprising a co-polyhydroxybutyrate. Co-polyhydroxybutyrate is a polyhydroxyalkanoate (PHA) polymer. PHA's are bio-based polymers that are produced by a wide range of microorganisms under deprived nutrients an excessive carbon sources. In general, PHA's have good biodegradability and are applied for several applications such as coffee capsules, food containers and straws.

Co-polyhydroxybutyrates are, for instance, described in Tang H J, Neoh S Z and Sudesh K (2022), “A review on poly(3-hydroxybutyrateco-3-hydroxyhexanoate) [P (3HB-co3HHx)] and genetic modifications that affect its production. Front. Bioeng. Biotechnol. 10:1057067 and in US2015/0132512. With co-polyhydroxybutyrate is meant a copolymer of hydroxybutyric acid and one or more other monomers, in particular a copolymer of 3-hydroxybutyric acid and one or more monomers selected from 4-hydroxybutyrate, 3-hydroxyvalerate, 5-hydroxyvalerate, 3-hydroxyhexanoate, 3-hydroxyoctanoate and 3-hydroxydodecanoate.

Preferably, the co-polyhydroxybutyrate is a copolymer of 3-hydroxybutyrate (3-HB) and 3-hydroxyhexanaoate (3-HH) monomer units, also denoted as poly-3-hydroxybutyrate-co-3-hydroxyhexanoate (PHBH). Preferably the PHBH comprises 5 to 20 mol % 3-hydroxyhexanoate.

The chemical structure of such a PHBH has formula (I)

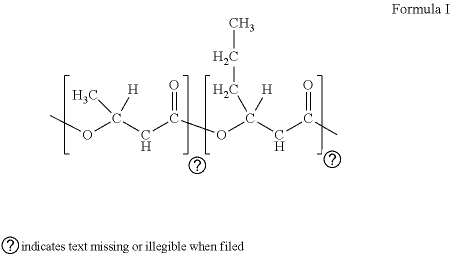

PHBH is commercially available in the market, for instance from Danimer Scientific, USA, KANEKA, Japan, RWDC, Singapore and USA, Bluepha, China. Most PHBH are obtained from the microorganisms C. necator or A. cavaie.

Preferably the polymer composition comprises a PHBH with a melt mass flow rate of 1 to 5 g/10 min according to ISO1133 at 160° C./5 kg. The PHBH is further characterized by a melt temperature Tm of 140-150° C., Tg of around 0° C. and a tensile strength of 5 to 50 MPa.

Melt temperature and Tg are determined by DSC with a heating rate of 10° C./min. Tensile strength is determined according to ISO527 at 10 mm/min.

### Natural Fibers

The first polymer composition of the invention comprises natural fibres. These fibres provide a natural look and feel to the exterior of the container. Such natural fibres are preferably cellulose based fibres from plants or wood. In particular, the natural fibres are selected from the group consisting of fibres from elephant grass, nettle, bamboo and wood.

Elephant grass fibres are obtained from miscanthus giganteus. Nettle fibres have a high cellulose content and have a high tenacity. They are hollow in structure, biodegradable and low in density.

The natural fibres typically have an aspect ratio L/D, defined as the average ratio between the length (L) and the largest of the width and thickness (D) of at least 2. Preferably, the aspect ratio of the natural fibres is at least 5, more preferably at least 10.

Suitable natural fibres typically have a length of 0.5 to 10 mm, preferably 1 to 5 mm and a diameter of 0.05 to 5 mm, preferably 0.1 to 2 mm.

Prior to incorporation of the fibres in the polymer, the fibres may be subjected to a drying step, for instance for 10 minutes to 6 hours in an oven at 30 to 100° C.

According to an embodiment the fibres can be pre-treated with a surface treatment prior to incorporation of the fibres in the polymer. Such a surface treatment may enhance compatibility of the fibres with the polymer and therefore better distribution of the fibre in the polymer and/or better bonding of the fibre to the polymer. Examples of surface treatments are polyethylene glycol (PEG) and maleic anhydride (MAH).

According to an embodiment, a surface treatment is used as described in WO2015/028633, which is incorporated herein by reference. In particular such a surface treatment comprises a compound A selected from triethylcitrate, tributylcitrate, trihexylcitrate, acetyltrietributylcitrate, propanoyltributylcitrate, acetyltrihexylcitrate and butanoyltriethylcitrate, a compound B, selected from ethylenebisstearamide, ethylenebislaureamide and ethylenebisoleamide, a compound C, selected from an ethoxylated sorbitan ester wherein the ester is substituted with four polyethylene glycol substituents, wherein the ester comprises between 18 and 22 ethylene glycol repeating units and wherein three of the ethylene glycol substituents are connected to oleate, stearate or laurate groups; and optionally a polymeric compound D. Preferably, the surface treatment comprises tributylcitrate, ethylenebislauramide and sorbitan polyoxyethylene (20)trioleate.

Typically, from 0.5 to 40 wt. % surface treatment, based on the weight of the fibres, is used. In view of the objects of the invention, the surface treatment should also be biodegradable.

An alternative pre-treatment of the natural fibres is treatment with NaOH.

According to an embodiment, the surface treatment is combined with the natural fibre before combining the fibre with the co-polyhydroxybutyrate. According to another embodiment, the surface treatment is combined simultaneously with the fibre and co-polyhydroxybutyrate, e.g. during extrusion.

The natural fibre can be mixed as such with the co-polyhydroxybutyrate. It is also possible to produce a masterbatch of the co-polyhydroxybutyrate and optionally the surface treatment, with the fibre and subsequently to mix the masterbatch with further co-polyhydroxybutyrate.

The first polymer composition preferably comprises 1 to 5 wt. % natural fibre. The amount of co-polyhydroxybutyrate in the first polymer composition is preferably from 90 to 99 wt. % based on the total weight of the first polymer composition.

### Container

In an embodiment, the container comprises further comprises at least a second layer of a composition comprising a second polymer composition comprising 95 to 100 wt. % co-polyhydroxybutyrate, based on the total weight of the second polymer composition, wherein the second layer constitutes the inner layer of the container and the layer of the first polymer composition constitutes the outer layer of the container. The second polymer composition may comprise 0 to 5 wt. % other components.

The second polymer composition preferably does not comprise natural fibres. The second layer thus provides structural integrity to the container whereas the first layer provides the look and feel of the container.

Optionally, one or more further layers can be added to the container.

The first and second polymer composition may also comprise other components. Such components comprise pigments, stabilizers, nucleating agents and mould release agents. Suitably, if used at all, the amount is limited to a range of 0.01 to 5 wt. %, or even 0.01 to 2.5 wt. % based on the total weight of the first polymer composition. The other components should also contribute to the object of the invention that the container is biodegradable or even home compostable. For instance, the pigment is an inorganic pigment.

The container may be any container that can be used to package food. For example, the container in accordance with the present invention may have the shape of a bottle or a jar. In one embodiment, the food container in accordance with the present invention may resemble or be a bottle. According to the Cambridge English Dictionary a bottle may be container for liquids with a narrow neck.

The first layer and second layer of the container may have a wall thickness in the range of 100 to 2500 μm, preferably 250 to 890 μm.

In one embodiment of the present invention, the first and/or second layer provide the barrier properties of the container. For example, the container may have a water vapor transmission rate (WWVTR) in the range of about less than 50 g/(m²×24 h), less than 8 g/(m²×24 h), or less than 5 g/(m² 2×24 h). The WVTR may be measured at 23° C., at a RH of 85%. For example, it may be measured in accordance with ISO 2528:1995.

The container in accordance with the present invention may have any volume that is used for food products. For example, the container may have a volume in the range of about 100 ml to 5 l, or 300 ml to 1 l.

The container can be used for water or water-based drinks such as vitamin containing water or other non-carbonated liquids such as juices and milk.

### Closure

According to a second aspect, the present invention provides a closure for the container. The closure also comprises co-polyhydroxybutyrate. In the embodiment where the container is a bottle, the closure is the cap of the bottle. The cap of the bottle preferably comprises a cap polymer composition comprising poly-3-hydroxybutyrate-co-3-hydroxyhexanoate (PHBH), more preferably PHBH with a MFR of 5 to 30 g/10 min. The Tm of the PHBH for the cap polymer composition is preferably from 140 to 150° C. The cap polymer composition may also comprise from 0.5 to 10 wt. % natural fibres.

### Degradation

The terms ‘biodegradation’ and ‘biodegradable’ generally refer to breakdown of organic matter by microbes, such as bacteria and fungi. These broad terms encompass various different types of microbial processes. Biodegradation can for instance refer to natural biodegradation processes, such as the breakdown of dead plant material into soil in a forest. Biodegradation can also refer to human-driven processes, such as composting, particularly aerobic composting. Anaerobic biodegradation processes, such as anaerobic composting, can also be used for biodegradation. However, anaerobic composting typically requires well-defined process conditions such as elevated temperatures and reduced pressure, which are difficult to control by consumers.

In order for containers to be readily compostable after use by a consumer, the container is preferably suitable for home composting. The term ‘home composting’ refers to composting processes that consumers can perform at home, for instance using a compost pile or compost bin in the garden. In such home composting processes, conditions like temperature and pressure typically do not have to be controlled very strictly, in contrast to anaerobic (e.g. industrial or municipal) composting processes.

During home composting, biodegradation typically takes place under aerobic conditions at atmospheric pressure, and due to the relatively low amounts of compost, the temperature of the composting pile does not increase as much above ambient temperatures as is generally the case in larger-scale aerobic compost piles. Therefore, home composting is generally slower than larger scale composting processes or composting processes in which the conditions such as temperature and pressure are well-controlled. The conditions and speed of home composting are similar to the conditions of biodegradation of e.g. dead plant material in a forest.

Preferably, the container according to the invention is compostable using home composting. This means that the beverage container will degrade under the conditions typically present in a composting pile of a consumer, but also under the conditions that are present when the beverage container is discarded in nature, e.g. in a forest. For instance, the beverage container degrades in 12 months or less under the conditions typically present in home composting, more preferably in 6 months or less.

In addition to the meaning of the terms ‘biodegradable’ and ‘biodegradability’ in this disclosure, the terms ‘biodegradable’ and ‘biodegradability’ may also be subject to certain environmental regulations. It is possible that the requirements for a material or a product to be considered or certified as biodegradable change over time.

When the beverage container of the invention is filled with a beverage, for instance drinking water, the inside of the container, which is in contact with the drinking water, is under anaerobic conditions. In order to be safe for drinking, drinking water or other beverages typically contain very low amounts of micro-organisms, i.e., substantially no micro-organisms, or no micro-organisms at all. Therefore, the inside of the filled container is not susceptible to biodegradation under the conditions present in home composting. In contrast, when the beverage container is empty, and especially when the empty beverage container is discarded in a location in which microbes that can digest the materials of the container are present, such as a home compost pile or forest soil, both the inside and the outside surfaces of the beverage container are under aerobic conditions and susceptible to biodegradation.

Biodegradability is more in particular understood as the capability of the material to be broken down by micro-organisms in the presence of oxygen to CO₂, water and mineral salts of any other elements present (mineralization) and new biomass or in the absence of oxygen to carbon dioxide, methane, mineral salts and new biomass. This property may be measured with a laboratory standard test method. In order to show complete biodegradability, a biodegradation level of at least 90% must be reached in less than 6 months. The applicable norm is EN 13432 (Packaging-Requirements for Packaging recoverable through composition and biodegradation). Preferably the container is home compostable within at most 6 months.

A further advantage of the invention is that the container biodegrades into components that can be used as compost and thus as nutrients for soil and plant growth.

Although biodegradable, the container should have sufficient shelf life to allow the product to be shipped and stocked, for instances at the manufacturer, shop and consumer. The container of the invention can be stocked for at least 12 months without losing structural integrity and affecting the quality of the product contained in the container. The advantage of this shelf life is further that during this period, the user of the container can re-use and refill the container.

Overall testing of the container for suitability as food packaging is important. Migration testing (OML) is a critical part of ensuring the safety of materials in contact with food. The simulants and testing conditions are determined by the food contact plastic regulation (EU 10/2011) and the tests are performed according to the EN 1186 standard. General compliance testing package for single-use plastic food contact materials (FCMs) by regulation (EU) 10/2011 and (EC) 1935/2004, article 3. This testing package includes the following tests:—Overall migration testing for all food types (simulants A, B, and D2)-Sensory testing (odor and taste) according to DIN 10955-Specific migration of ammonium ion and elements listed in Annex II of EU 10/2011-Specific migration of non-intentionally added substances (NIAS) to simulant D2e (95% ethanol) with GC-MS screening analysis

### Process of Manufacture

According to a third aspect, the invention provides an extrusion blow moulding process for producing a container as disclosed herein, comprising the steps of:
a) providing a mould for a container;
b) producing a parison, said parison comprising a first polymer composition comprising 80 to 99.5 wt. % of a co-polyhydroxybutyrate, 0.5 to 10 wt. % natural fibre and 0 to 10 wt. % other components, based on the weight of the first polymer composition;
c) expanding the parison into the mould to shape a first layer of the container.

In step c), the stretch ratio is for instance 1 to 20. Preferably, the stretch ratio with respect to volume of the parison is between 1 and 10. During the step of expanding the parison, the length, diameter, and/or volume are increased.

Preferably, the expanding in the method as described herein is performed using blow moulding by injecting a gas, such as air or nitrogen, in the interior of the parison.

The parison, a thin-walled tube, can be produced by conventional processes such as extrusion. Release agents may be present in the polymer composition of the parison or can be applied to the mould, in order to facilitate the release of the moulded container from the mould.

Thus, in general terms, the process takes the parison, which has been formed by extrusion out of an annular die, entraps it between two halves of a larger diameter mould and then expands it by blowing gas (air) (at about 0.5 MPa) into the tube, forcing the parison out against the mould. The outside of the thin-walled tube takes the shape of the inside of the mould.

The conditions for producing the container are such that the polymer composition shows the appropriate crystallisation behaviour after forming the container. This means that the shear in the extruder should be relatively low and that a relatively short residence time in the extruder is applied.

The temperature in the extruder is from 140 to 165° C.

The mould is pre-shaped as a bottle including the neck and thread for later placement of a cap.

According to a preferred embodiment, in step b) the parison further comprises a second polymer composition comprising 95 to 100 wt. % of a co-polyhydroxybutyrate, based on the weight of the second polymer composition and
wherein in step c) the parison is expanded into the mould to shape the first and second layer of the container, wherein the second layer constitutes the inner layer of the container and the first layer constitutes the outer layer of the container.

In this preferred embodiment, at least two extruders are used to melt and plasticize the polymer compositions followed by compounding, extruding and forming multi-layer concentric parison. The basic process principle is the same as the single-layer blow moulding technique. Only the moulding equipment uses several extruders to plasticize different polymer compositions.

Similarly, further layers of the container can be formed. It is also possible to provide a layer as a foam.

The first polymer composition can be provided to the process as separate inputs of co-polyhydroxybutyrate (PHBH) and natural fibres. It is also possible to have a step preceding step a) of the process comprising compounding the co-polyhydroxybutyrate and natural fibres such as to provide pellets. The pellets of the polymer composition can be extruded to produce the parison.

The process may also comprise a step of pre-treating the fibres with a surface treatment. The surface treatment may also be added during compounding to produce the first polymer composition.

According to an alternative embodiment, the process comprises a step preceding the compounding step, wherein a masterbatch is formed of the co-polyhydroxybutyrate, the natural fibres and optionally the surface treatment. The masterbatch is then further processed with co-polyhydroxybutyrate during step b) of the process.

Advantageously, the equipment required for the process moulding may be the same equipment that is currently used on a large scale to produce (beverage) containers from conventional plastics.

As described above, according to an embodiment, the container is a bottle and the present invention also comprises the cap for the bottle. The cap can be produced using injection moulding of a co-polyhydroxybutyrate with a melt flow rate of 5 to 30 g/10 min according to ISO1133 at 160° C. and 5 kg.

The preferred embodiments for the polymer compositions, co-polyhydroxybutyrate and natural fibres are as described above for the container.

### EXAMPLES

### Materials

PHBH1 was obtained from Kaneka: Kaneka Green Planet™ X131N having the properties:

| | Typical | | Test | | |
|---|---|---|---|---|---|
| Properties | Value | Unit | Condition | | Standard |
| Melt mass-flow rate | 3 | g/10 min | 160° C./5 kg | | ISO 1133 |
| Tensile Strength | 25 | MPa | 10 mm/min | | ISO 527 |
| Strain at break | <10 | % | 10 mm/min | | ISO 527 |
| Flexural Modulus | 1600 | MPa | 2 mm/min | | ISO 178 |
| Charpy notched impactstrength | <5 | kJ/m² | 23° | C. | ISO 179-1eA |
| Melting Temperature, Tm | 145 | ° C. | 10° | C./min | DSC |
| Glass Transition Temperature, Tg | 0 | ° C. | 10° | C./min | DSC |
| Temperature of deflection under load | 110 | ° C. | 0.45 | MPa | ISO 75-1, -2 |

PHBH2 was obtained from Kaneka: Kaneka Green Planet™ X331N having the properties:

| | Typical | | Test | | |
|---|---|---|---|---|---|
| Properties | Value | Unit | Condition | | Standard |
| Melt mass-flow rate | 10 | g/10 min | 160° C./5 kg | | ISO 1133 |
| Tensile Modulus | 1600 | MPa | 10 mm/min | | ISO 527-1, -2 |
| Strain at break | 4 | % | 10 mm/min | | ISO 527-1, -2 |
| Flexural Modulus | 1600 | MPa | 2 mm/min | | ISO 178-A |
| Flexural Strength | 44 | MPa | 2 mm/min | | ISO 178-A |
| Charpy notched impact strength | 2 | kJ/m² | 23° | C. | ISO 179-1eA |
| Melting Temperature, Tm | 145 | ° C. | 10° | C./min | DSC |
| Glass Transition Temperature, Tg | 0 | ° C. | 10° | C./min | DSC |
| Temperature of deflection under load | 116 | ° C. | 0.45 | MPa | ISO 75-1, -2 |

Natural miscanthus fibres were obtained from Miscanthusgroep Haarlemmermeer. The fibres had a length of L of 1,75+/−0,05 in the granulate and thickness D of 0,12+/−0.02 mm.

A03 is a surface treatment from Innosolids consisting of tributylcitrate (37%) ethylenebislauramide (19%) en sorbitan polyoxyethylene (20)trioleate (44%) by weight percentage.

### Polymer Composition 1

Polymer composition 1 consists of PHBH1.

### Polymer Composition 2

40 kg of a Polymer composition 2 was prepared by compounding 97.5 wt. % PHBH1, 2 wt. % fibre and 0.5 wt. % A03 on a ZSK twin screw extruder with L/D 36 at 285 rpm with a temperature of 150-180° C. Residence time in the extruder was from 30 to 60 seconds.

### Comparative Example 1

A 500 ml bottle was produced by extrusion blow moulding. A parison with a diameter of 27.8 mm was formed having an outer and inner layer. The outer layer was extruded from polymer composition 1 in an extruder with extruder size 30/25 D at 27 RPM with a temperature from 140-155° C. The inner layer was extruded from polymer composition 1 in an extruder with extruder size 25/25 D at 21 RPM with a temperature from 140-155° C. A bottle was blown with a blowing time of 12 s and a blowing pressure of 5.0 bar (0.5 MPa).

### Example 1

A 500 ml bottle was produced by extrusion blow moulding. A parison with a diameter of 28.3 mm was formed having an outer and inner layer. The outer layer was extruded from polymer composition 2 in an extruder with extruder size 30/25 D at 30 RPM with a temperature from 135-145° C. The inner layer was extruded from polymer composition 2 in an extruder with extruder size 25/25 D at 40 RPM with a temperature from 135-140° C. A bottle was blown with a blowing time of 12 s and a blowing pressure of 5.0 bar (0.5 MPa).

### Example 2

A 500 ml bottle was produced by extrusion blow moulding. A parison with a diameter of 28.7 mm was formed having an outer and inner layer. The outer layer was extruded from polymer composition 2 in an extruder with extruder size 30/25 D at 24 RPM with a temperature from 135-145

1. A container comprising at least one layer of a first polymer composition comprising 80 to 99.5 wt. % of a co-polyhydroxybutyrate, 0.5 to 10 wt. % natural fibre and 0 to 10 wt. % other components, based on the weight of the first polymer composition.

2. The container according to claim 1, wherein the co-polyhydroxybutyrate is poly-3-hydroxybutyrate-co-3-hydroxyhexanoate (PHBH).

3. The container according to claim 1 or 2 wherein the PHBH has a melt flow rate of 1 to 5 g/10 min according to ISO1133 at 160° C. and 5 kg.

4. The container according to any one of claims 1 to 3, wherein the PHBH has a melt temperature of 140 to 150° C.

5. The container according to any one of the preceding claims, wherein the first polymer composition comprises 1 to 5 wt. % natural fibre.

6. The container according to any one of the preceding claims, wherein the natural fibre is a cellulose based fibre, preferably selected from elephant grass fibres, nettle fibres, bamboo fibres and wood fibres.

7. The container according to any one of the preceding claims, wherein the natural fibre has a surface treatment.

8. The container according to any one of the preceding claims, further comprising a second layer of a second polymer composition comprising 95 to 100 wt. % of a co-polyhydroxybutyrate and 0 to 5 wt. % other components, based on the weight of the second polymer composition, wherein the second layer constitutes the inner layer of the container and the first polymer composition constitutes the outer layer of the container.

9. The container according to claim 8, wherein the second polymer composition contains 0 to 2 wt. % other components, and wherein preferably, the other components are not natural fibres.

10. The container according to any one of the preceding claims, which is a beverage container, preferably a bottle and wherein preferably the beverage is water or a water-based beverage.

11. A closure for a container according to any one of the preceding claims, wherein the closure comprises a co-polyhydroxybutyrate with a melt flow rate of 5 to 30 g/10 min according to ISO1133 at 160° C. and 5 kg.

12. The closure according to claim 11, wherein the co-polyhydroxybutyrate is poly-3-hydroxybutyrate-co-3-hydroxyhexanoate) (PHBH).

13. The closure according to claim 11 or 12, which further comprises natural fibre.

14. The closure according to any one of claims 11 to 13, which is a cap for a bottle.

15. A process for producing a container according to any one of claims 1 to 10, comprising the steps of:
a) providing a mould for the container;
b) producing a parison, wherein the parison comprises a first polymer composition comprising 80 to 99.5 wt. % of a co-polyhydroxybutyrate 0.5 to 10 wt. % natural fibre and 0 to 10 wt. % other components, based on the weight of the first polymer composition;
c) expanding the parison into the mould to shape a first layer of the container.

16. The process according to claim 15, wherein the in step c) is carried out by injecting a gas in the interior of the parison.

17. The process according to claim 15 or 16, wherein the parison is produced by extruding the first polymer composition out of an annular die.

18. The process according to any one of claims 15 to 17, wherein in step b) the parison further comprises a second polymer composition comprising 95 to 100 wt. % of a co-polyhydroxybutyrate and 0 to 5 wt. % other components, based on the weight of the second polymer composition and wherein in step c) the parison is expanded into the mould to shape the first and second layer of the container, wherein the second layer constitutes the inner layer of the container and the first layer constitutes the outer layer of the container.
